(19) United States
(12) Patent Application Publication
(10) Pub. No.: US 2022/0198949 A1
(43) Pub. Date: Jun. 23, 2022

(54) SYSTEM AND METHOD FOR DETERMINING REAL-TIME ENGAGEMENT SCORES IN INTERACTIVE ONLINE LEARNING SESSIONS

(71) Applicant: Vedantu Innovations Pvt. Ltd., Bangalore (IN)

(72) Inventors: Pulkit JAIN, Bengaluru (IN); Pranav R. MALLAR, Bengaluru (IN)

(73) Assignee: Vedantu Innovations Pvt. Ltd., Bangalore (IN)

(21) Appl. No.: 17/174,466

(22) Filed: Feb. 12, 2021

(30) Foreign Application Priority Data
Dec. 22, 2020 (IN) 202041055779

(51) Int. Cl. G09B 5/12; G06N 20/00; G06Q 50/20

(52) U.S. Cl. CPC G09B 5/125; G06Q 50/20; G06N 20/00

(57) ABSTRACT

A system for determining real-time learner engagement scores in interactive learning sessions delivered via an online learning platform is presented. The system includes a data module and a processor operatively coupled to the data module. The processor includes a feature generator, a training module, an engagement score generator, and a notification module. A related method is also presented.

### PRIORITY STATEMENT

The present application claims priority under 35 U.S.C. § 119 to Indian patent application number 202041055779 filed Dec. 22, 2020, the entire contents of which are hereby incorporated herein by reference.

### BACKGROUND

Embodiments of the present invention generally relate to systems and methods for determining engagement scores in online interactive learning sessions, and more particularly to automated systems and methods for determining real-time learner engagement scores in online interactive learning sessions.

Online learning systems represent a wide range of methods for electronic delivery of information in an education or training set-up. More specifically, interactive online learning systems are revolutionizing the way education is imparted. Such interactive online learning systems offer an alternate platform that is not only faster and potentially better but also bridges the accessibility and affordability barriers for the learners. Moreover, online learning systems provide learners with the flexibility of being in any geographic location while participating in the session.

Apart from providing convenience and flexibility, such online learning systems also ensure more effective and engaging interactions in a comfortable learning environment. With the advancement of technology, personalized interactive sessions are provided according to specific needs rather than just following a set pattern of delivering knowledge as prescribed by conventional educational institutions. Moreover, such a system allows a mobile learning environment where learning is not time-bound (anywhere-anytime learning).

However, there is a need to monitor such interactions and to measure the engagement levels of learners in such online learning systems. Currently, the effectiveness of such interactive learning systems is manually reviewed (e.g., by delivering quizzes and/or taking feedbacking surveys). Such manual interventions could be time-consuming and less scalable. Moreover, reviews done in such manner lead to subjective and inaccurate ratings. Further, such reviews are conducted after a learning session is completed on the online learning systems, and thus do not provide real-time data on engagement levels of learners to the instructors.

Thus, there is a need for automated systems and methods capable of determining engagement of the learners in online interactive learning sessions. Further, there is a need for systems and methods capable of determining real-time engagement of the learners in online interactive learning sessions.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system for determining real-time learner engagement scores in interactive learning sessions delivered via an online learning platform is presented. The system includes a data module and a processor operatively coupled to the data module. The data module is operatively coupled to the online learning platform and a plurality of computing devices used by a plurality of learners to engage in the learning sessions, the data module is configured to access in-session data corresponding to a plurality of learning sessions attended by a first plurality of learners, post-session data corresponding to the plurality of learning sessions attended by the first plurality of learners, and class data for the first plurality of learners. The processor includes a feature generator configured to generate a plurality of in-session features based on the in-session data; a plurality of post-session features based on the post-session data, and a plurality of class features based on the class data. The data further includes a training module configured to train an AI model based on the plurality of in-session features, the plurality of post-session features, and the plurality of class features. The processor furthermore includes an engagement score generator configured to generate, in-real-time, from the trained AI model: (i) a composite learner engagement score, and (ii) individual learner engagement scores for a live learning session attended by a second plurality of learners, based on real-time in-session features generated from real-time in-session data for the live learning session. The processor moreover includes a notification module configured to transmit: (i) the composite learner engagement score, and (ii) individual learner engagement scores and corresponding IDs of one or more selected learners from the second plurality of learners to one or more instructors delivering the learning session.

According to another example embodiment, a system for determining real-time learner engagement scores in interactive learning sessions delivered via an online learning platform is presented. The system includes a memory storing one or more processor-executable routines; and a processor cooperatively coupled to the memory. The processor is configured to execute the one or more processor-executable routines to access: in-session data for a plurality of learning sessions attended by a first plurality of learners, post-session data corresponding to the plurality of learning sessions attended by the first plurality of learners, and class data for the first plurality of learners. The processor is further configured to generate: a plurality of in-session features based on the in-session data, a plurality of post-session features based on the post-session data, and a plurality of class features based on the class data. The processor is further configured to train an AI model based on the plurality of in-session features, the plurality of post-session features, and the plurality of class features. The processor is furthermore configured to access real-time in-session data for a live learning session attended by a second plurality of learners and generate a plurality of real-time in-session features for the live learning session based on the real-time in-session data. The processor is further configured to generate, in real-time, from the trained AI model: (i) a composite learner engagement score, and (ii) individual learner engagement scores for the live learning session, based on real-time in-session features for the live learning session. The processor is moreover configured to transmit (i) the composite learner engagement score, and (ii) the individual learner engagement scores and corresponding IDs of one or more selected learners from the second plurality of learners to one or more instructors delivering the live learning session.

According to another example embodiment, a method for determining real-time learner engagement scores in interactive learning sessions delivered via an online learning platform is presented. The method includes accessing: in-session data for a plurality of learning sessions attended by a first plurality of learners, post-session data corresponding to the plurality of learning sessions attended by the first plurality of learners, and class data for the first plurality of learners. The method further includes generating: a plurality of in-session features based on the in-session data; a plurality of post-session features based on the post-session data, and a plurality of class features based on the class data. The method furthermore includes training an AI model based on the plurality of in-session features, the plurality of post-session features, and the plurality of class features. The method further includes accessing real-time in-session data for a live learning session attended by a second plurality of learners and generating a plurality of real-time in-session features for the live learning session based on the real-time in-session data. The method furthermore includes generating, in real-time, from the trained AI model: (i) a composite learner engagement score, and (ii) individual learner engagement scores for the live learning session, based on real-time in-session features for the live learning session. The method moreover includes transmitting (i) the composite learner engagement score, and (ii) the individual learner engagement scores and corresponding IDs of one or more selected learners from the second plurality of learners to one or more instructors delivering the live learning session.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating an example online learning environment, according to some aspects of the present description,

FIG. 2 is a block diagram illustrating an example data module communicatively coupled to a plurality of learner computing devices, according to some aspects of the present description,

FIG. 3 is a block diagram illustrating an example data module communicatively coupled to a learner computing device, according to some aspects of the present description,

FIG. 4 is a block diagram illustrating an example system for generating learner engagement scores, according to some aspects of the present description,

FIG. 5 is a block diagram illustrating an example system for generating learner engagement scores, according to some aspects of the present description,

FIG. 6 is a block diagram illustrating an example notification module communicatively coupled to an instructor computing device, according to some aspects of the present description,

FIG. 7 is a block diagram illustrating an example system for generating learner engagement scores, according to some aspects of the present description,

FIG. 8 is a flow chart illustrating an example method for generating learner engagement scores, according to some aspects of the present description,

FIG. 9 is a plot showing real-time learner composite engagement scores, according to some aspects of the present description, and

FIG. 10 is a block diagram illustrating an example computer system, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Example embodiments of the present description provide automated systems and methods for determining real-time learner engagement scores, using a trained AI model, in interactive learning sessions delivered via an online learning platform.

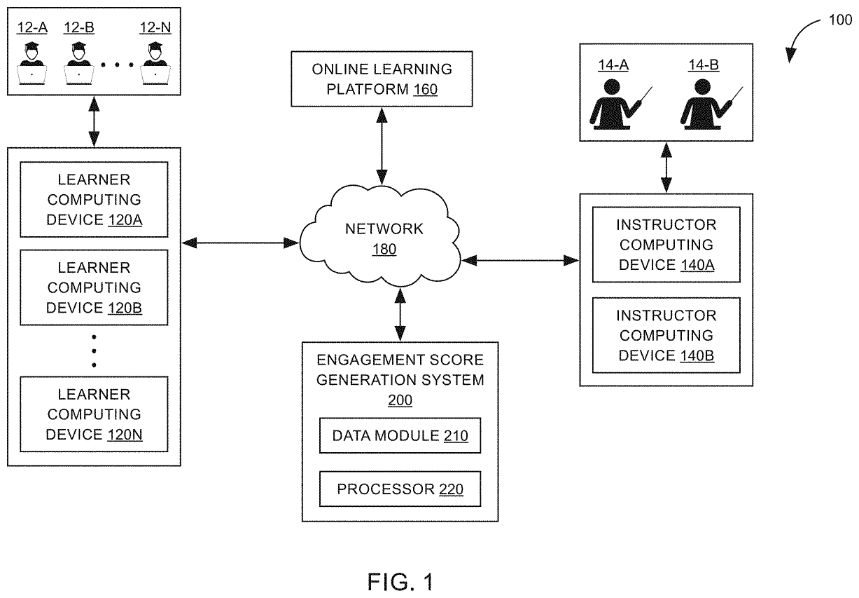

FIG. 1 illustrates an example online interactive learning environment 100 configured to provide an interactive learning session (which is hereafter simply referred to as the “learning session”), in accordance with some embodiments of the present description. The term “interactive learning session” as used herein refers to live learning sessions (e.g., using at least live audio or video) delivered via online learning platforms by the instructors, which allow for real-time interactions between the instructors and the learners. This is in contrast to pre-recorded learning sessions that are available on online learning platforms.

The online interactive learning environment includes a plurality of learners 12A, 12B . . . 12N (collectively represented by reference numeral 12) and one or more instructors 14A, 14B (collectively represented by reference numeral 14). As used herein, the term “instructor” refers to an entity that is imparting information to the plurality of learners 12 during the learning session. It should be noted that although FIG. 1 shows two instructors for illustration purposes, the number of instructors may vary, and may depend on the learning requirements of the learning session. In some instances, the number of instructors may depend on the number of learners attending the learning session. The plurality of learners 12 may include more than 20 learners in some embodiments, more than 100 learners in some embodiments, and more than 500 learners in some other embodiments.

Non-limiting examples of such interaction sessions may include training programs, seminars, classroom sessions, and the like. In some embodiments, the instructor is a teacher, the learner is a student, and the interaction session is aimed at providing educational content. In such instances, the plurality of learners 12 may collectively constitute a class. As noted earlier, the plurality of learners 12 may be located at different geographical locations while engaging in the online interactive learning session and may belong to same or different demographics.

The online learning environment 100 further includes a plurality of learner computing devices 120A, 120B . . . 120N. The learner computing devices are configured to facilitate the plurality of learners 12 to engage in the online learning session, according to aspects of the present technique. Non-limiting examples of learner computing devices include personal computers, tablets, smartphones, and the like. In the embodiment illustrated in FIG. 1, each learner computing device corresponds to a particular learner, e.g., learner computing device 120A corresponds to learner 12A, learner computing device 120B to learner 12B, and so on. Similarly, the online learning environment 100 further includes a plurality of instructor computing devices 140A and 140B. The instructor computing devices are configured to facilitate the plurality of instructors to deliver the online learning session. Non-limiting examples of instructor computing devices include personal computers, tablets, smartphones, and the like. In the embodiment illustrated in FIG. 1, each instructor computing device corresponds to a particular instructor, e.g., instructor computing device 140A corresponds to instructor 14A, instructor computing device 140B to instructor 14B, and so on.

The interactive online learning environment 100 further includes an online learning platform 160. The online learning platform 160 is used by the plurality of learners 12 to access the learning sessions and by the one or more instructors 14 to deliver the learning sessions. The learning sessions are delivered by the one or more instructors live (e.g., in a virtual live classroom) via the learning platform 160. The learning platform 160 may be accessed via a web-page or via an app on the plurality of computing devices used by the plurality of learners 12. As described in detail later, the online learning platform 160 includes one or more interactive tools that facilitate interaction between the plurality of learners 12 or between the plurality of learners 12 and the one or more instructors 14, in real-time.

The various components of the online learning environment 100 may communicate through the network 180. In one embodiment, the network 180 uses standard communications technologies and/or protocols. Thus, the network 180 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 180 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc.

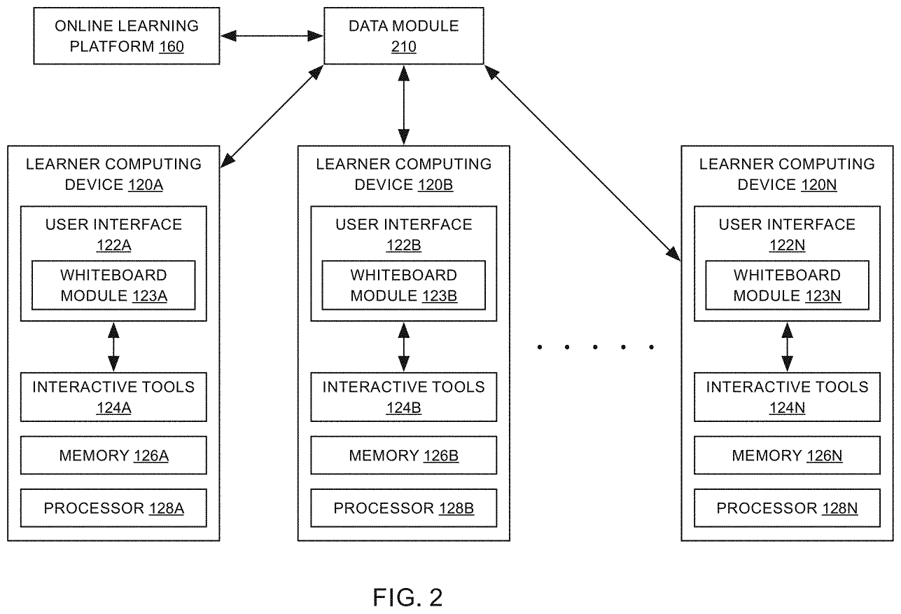

The online learning environment 100 further includes an engagement score generation system 200 (hereinafter referred to as “system”) for determining real-time learner engagement scores in learning sessions delivered by the online learning platform 160. The system 200 includes a data module 210 and a processor 220. Each of these components is described in detail below with reference to FIGS. 2-4.

The data module 210 is configured to access one or more of: in-session data for one or more learning sessions, post-session data corresponding to the one or more learning sessions, and class data for the learners attending the one or more learning sessions. The data module 210 may be configured to access the in-session data, the post-session data, and the class data from the computing devices associated with the learners as well as from the online learning platform 160. The in-session data, the post-session data, and class data may be used as training data as described in detail later. Further, in-session data accessed in real-time may be used to generate the real-time engagement scores.

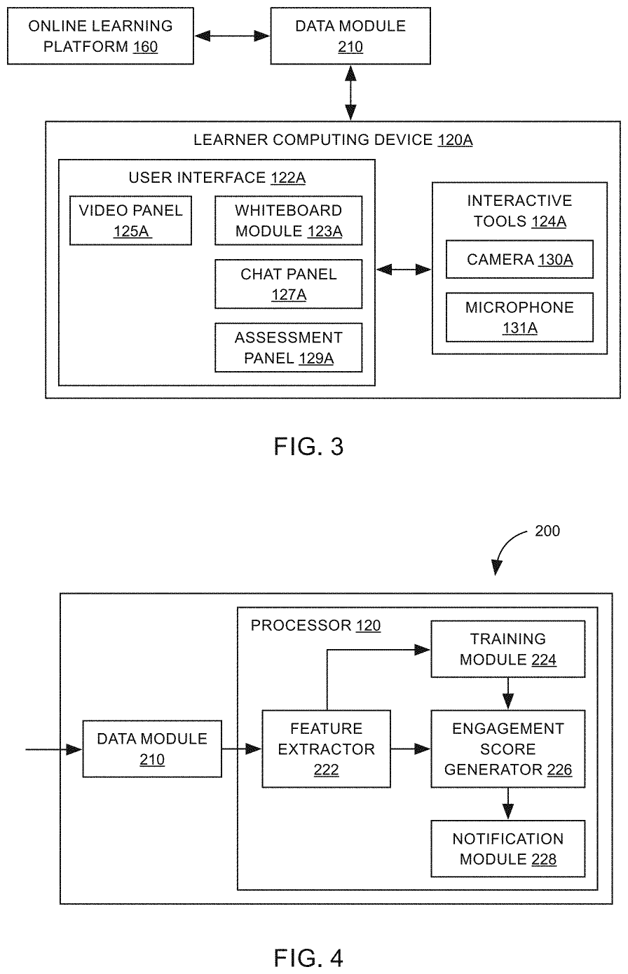

FIGS. 2 and 3 illustrate an example embodiment where the data module 210 is configured to access in-session data from the plurality of learners 12 and the learning platform 160. As shown in FIGS. 2 and 3, data module 210 is communicatively coupled to the plurality of computing devices 120A, 120B . . . 120N used by the plurality of learners 12 to engage in the online learning session. In some embodiments, the data module may also be communicatively coupled to one or more computing devices 140A and 140B used by the one or more instructors 14A and 14B to deliver the online learning session (not shown in FIGs.). The learner computing devices 120A . . . 120N include among other components, user interface 122A . . . 122N, interactive tools 124A . . . 124N, memory unit 126A . . . 126N, and processor 128A . . . 128N.

FIG. 3 illustrates a learner computing device 120A in more detail. The user interface 122A of the learner computing device 120A includes the whiteboard module 123A, a video panel 125A, a chat panel 127A, and an assessment panel 129A. Interactive tools 124A may include, for example, a camera 130A, and a microphone 131A, and are used to capture video, audio, and other inputs from the learner 12A.

Whiteboard module 123A is configured to enable the learners 12 and the one or more instructors 14 to communicate amongst each other by initiating an interaction session by submitting written content. Examples of written content include alpha-numeric text data, graphs, figures, scientific notations, gifs, and videos. The whiteboard module 123A may further include formatting tools that would enable each user to ‘write’ in the writing area. Examples of formatting tools may include a digital pen for writing, a text tool to type in the text, a color tool for changing colors, a shape tool used for generating figures and graphs. In addition, an upload button may be included in the whiteboard module 123A for uploading images of pre-written questions, graphs, conceptual diagrams, and other useful/relevant animation representations.

Video panel 125A is configured to display video signals of a selected set of participants of the learning session. In one embodiment, the video data of a participant (learner or instructor) that is speaking at a given instance is displayed on the video panel 121A. Chat panel 127A is configured to enable all participants to message each other during the course of the learning session. In one embodiment, the messages in the chat panel 127A are visible to all participants engaged in the learning session.

Assessment panel 129A is configured to enable a learner to engage in different in-session assessments (e.g., quizzes, hot spot-interactions, and the like) during the course of the learning session. In one embodiment, the inputs in the assessment panel 129A are visible to only the learner submitting the assessment (e.g, learner 12A in this instance). The interactive tools 124A may include a camera 130A for obtaining and transmitting video signals and a microphone 131A for obtaining audio input. In addition, the interactive tools 124A may also include mouse, touchpad, keyboard, and the like.

As noted earlier, the data module 210 is configured to access in-session for one or more learning sessions. Non-limiting examples of in-session data include whiteboard data, audio data, video data, messaging data, browsing data, or in-session assessment data. In some embodiments, the data module 210 is configured to access in-session data in real-time for a live learning session. The real-time in-session data is used to calculate real-time learner engagement scores, as described in detail later.

The term “audio data” as used herein refers to the audio content recorded from the microphones of the corresponding computing devices as well as the data accessed by processing the audio content such as tonality, flow, sentiment, confidence levels, and the like. Non-limiting examples of audio data include sentiment data, stress level data, confidence level data, ambient noise level data, or combinations thereof. The confidence level data may be generated based on the tone, emphasis, and articulation of a learner.

The term “video data” as used herein refers to the video content recorded from the cameras of the corresponding computing devices as well as the data accessed by processing the video content such as emotion, attention levels, interest levels, and the like. Non-limiting examples of video data include emotion metric, attentiveness metric, point of interest, involvement level of one or more persons proximate to the learner, or combinations thereof. In one embodiment, the attentiveness metric may be determined based on whether the learner is facing the learning platform/computing device or not. Further, the point of interest on a screen may be determined based on eye gaze detection. The level of involvement of other persons may be determined based on the number of persons proximate to the learner and by identifying their approximate age.

The term “whiteboard data” as used herein refers to the whiteboard content recorded from the whiteboard modules of the corresponding computing devices. Non-limiting examples of whiteboard data include: writing length of the written content, writing time of written content, number of pages used in the whiteboard module, colours used in the whiteboard module, figures, graphs, images, gifs, or videos uploaded to the whiteboard module, relevancy to the interaction session of the whiteboard data submitted to the whiteboard module, or combinations thereof.

The term “messaging data” as used herein refers to the messaging content recorded from the chat modules of the corresponding computing devices as well as the data accessed by processing the messaging content such as sentiment, attention levels, and the like. Non-limiting examples of messaging data include: frequency of messages, the participant to whom the message is addressed (e.g., a learner or an instructor), sentiment of the message, peer involvement (i.e., involvement of other learners) with the message, intent classification of a message, or combinations thereof. An intent of a message may be classified, for example, based on the inputs provided by a learner in the message. Non-limiting examples of an intent may include positive or negative response to a method of delivering the learning session (e.g., whiteboard module, videos, and the like), positive or negative response to a pedagogy employed by the one or more instructors, or request for repetition of a particular topic or subject matter. In some embodiments, messaging data may further include a response from the instructor to a chat message by one or more learners and a response from the one or more learners regarding satisfaction level regarding the instructor's response.

The term “browsing data” as used herein refers to the browser content captured from corresponding computing devices as well as the data accessed by processing the browsing content such as fidgetiness scores and the like. Non-limiting examples of browsing data include the number of times a learner changes tabs on a browser being used to access the online learning session, frequency of cursor movement by the learner, or a combination thereof.

The term “in-session assessment data” as used herein refers to the data captured based on interactions such as quizzes, in-session prompts/questions, hotspot interactions, and the like. Non-limiting examples of in-session assessment data include in-session quiz metrics, responses to in-session close-ended questions, hotspot interaction metrics, or combinations thereof. The term “in-session quiz” as used herein refers to in-session assessments/tests that are administered during a learning session itself. Non-limiting examples of quiz metrics include the number of attempts, time to answer, level of questions answered, accuracy, and the like. In some embodiments, the in-session quizzes are administered by the in-session assessment panel. The close-ended questions may be answered by the learners via audio, in-session assessment panel, and the like.

In-session assessment data may also be measured by initiating a variety of interactions between the learners and the online learning platform/instructors. For example, along with conventional in-session quizzes, the online learning platform 160 may also enable other means of student assessment using one or more gamification techniques. In some embodiments, hotspots may be used to engage and assess the learners during a learning session. The term “hotspot” as used herein refers to a visible location on a screen that is linked to perform a specified task. Non-limiting examples of hotspot interactions may include selecting/matching a set of images, filling in the blanks, etc.

As noted earlier, the data module 210 is further configured to access the post-session data for one or more learning sessions. Non-limiting examples of post-session data include feedback survey data, post-session assessment data, attendance data, completion data, post-session doubts data, or combinations thereof.

Feedback survey data includes data from feedback surveys submitted by a learner after completing the one or more learning sessions. In some embodiments, the feedback survey data may be submitted by the learner on the online learning platform 160 after the one or more learning sessions are completed.

The term “post-session assessment data” as used herein refers to data obtained from post-session tests and/or assignments completed by a learner after attending one or more learning sessions. Non-limiting examples of test metrics include the total number of tests given, total number of tests taken, total number of questions attempted, accuracy of the attempted questions, total number of incorrect questions, type of mistakes, time spent on accurate answers, time spent on inaccurate answers, levels of questions answered, total number of assignments given, total number of assignments taken, accuracy on the assignments, and the like.

Completion ratio is estimated based on percentage completion of tasks for one or more learning sessions such as tests, assignments, videos, and the like. Attendance ratio is estimated based on the percentage of sessions attended, time spent in the sessions, and the like.

The term “post-session doubt data” as used herein refers to any data related to doubts submitted by a learner for a particular learning session after the learning session and/or a post-session assessment related to the session is completed. Non-limiting examples of post-session doubt data may include frequency of doubts submitted, number of doubts resolved, feedback associated with doubts resolution, the type and/or level of questions raised in the doubts, time between the learning session/test, and doubt submission, or combinations thereof. The post-session doubt data may be further tagged by metadata such as topic, content, learner ID, instructor ID, and the like.

The data module 210 is further configured to access the class data for a plurality of learners. Non-limiting examples of class data include demographic data, overall academic performance data, online platform usage data, historical subject-based assessment data, historical in-session activity data, historical attendance data, historical completion data, or combinations thereof.

Non-limiting examples of demographic data include school category, school tier, school location, grade level, goal (e.g., tuition, entrance exam, Olympiad, etc.,), or combinations thereof. Overall academic performance data may be generated using time series analysis and the learners may be classified based on the percentiles. Online platform usage data may be generated using time series analysis and may be based on how frequently a learner interacts with the online platform, types of interaction, and the type of features used on the platform.

Historical subject-based assessment data is also generated using time series analysis based on post-session tests and/or assignments completed by a learner for a particular subject and/or a set of subjects. Non-limiting examples of test metrics include total number of tests given, total number of tests taken, total number of questions attempted, accuracy of the attempted questions, total number of incorrect questions, type of mistakes, time spent on accurate answers, time spent on inaccurate answers, levels of questions answered, total number of assignments given, total number of assignments taken, accuracy on the assignments, and the like.

Historical in-session activity data is estimated based on time-series analysis of in-session data for multiple learning sessions. Historical attendance ratio is estimated using time series analysis based on percentage of sessions attended, time spent in the sessions, and the like. Historical completion ratio is estimated using time series analysis based on percentage completion of tasks for a particular session such as tests, assignments, videos, and the like.

As noted earlier, the system 200 further includes a processor 220. FIG. 4 illustrates an example engagement score generation system 200 including the data module 210 and the processor 220. The processor 220 includes a feature generator 222, a training module 224, an engagement score generator 226, and a notification module 228. Each of these components is further described in detail below.

The feature generator 222 is configured to generate a plurality of in-session features based on the in-session data; a plurality of post-session features based on the post-session data, and a plurality of class features based on the class data. The plurality of in-session features, the plurality of post-session features, and the plurality of class features are presented as training data by the feature generator 222 to the training module 224. In some embodiments, the feature generator 222 is further configured to generate the plurality of in-session features in real-time. The plurality of real-time in-session features is used by the engagement score generator 226 to generate the real-time learner engagement scores, as described in detail later.

The training module 224 is configured to train an AI model based on the training data. Non-limiting examples of suitable AI models include long short term memory recurrent neural network, convolutional neural network, or a combination thereof. In some embodiments, the training module 224 is further configured to train the AI model based on an instructor quotient. The instructor quotient may be calculated based on in-session data from the one or more instructors, such as video data, audio data, content data, whiteboard data, and the like. The training module 224 may be further configured to train the AI model based on or more additional suitable data, not described herein.

In some embodiments, the training module 224 is configured to train the AI model at defined intervals, e.g., weekly, bi-weekly, fortnightly, monthly etc. In such instances, the training data may be presented to the training module 224 at a frequency determined by a training schedule. In some other embodiments, the training module 224 is configured to train the AI model continuously in a dynamic manner. In such embodiments, the training data may be presented to the training module 224 continuously. The training module is further configured to present the trained AI model to the engagement score generator 226.

The engagement score generator 226 is configured to generate, in-real-time, from the trained AI model: (i) a composite learner engagement score, and (ii) individual learner engagement scores for a live learning session based on real-time in-session features generated from real-time in-session data for the live learning session. As mentioned earlier, the real-time in-session features are generated by the feature generator 222 based on real-time in-session data accessed by the data module 210 for the live learning session. In some embodiments, the engagement score generator 226 is configured to generate the composite learner engagement score and the individual learner engagement scores continuously during the duration of the learning session.

The notification module 228 is configured to transmit: (i) the composite learner engagement score, and (ii) individual learner engagement scores and corresponding IDs of one or more selected learners to one or more instructors delivering the live learning session. The term “composite learner engagement score” as used herein refers to an overall engagement score for the entire class of the plurality of learners attending the learning session

In some embodiments, the notification module 238 is configured to transmit the composite engagement score of the plurality of learners continuously, and (ii) individual learner engagement scores and corresponding IDs of the one or more selected learners at defined intervals during the duration of the live learning session.

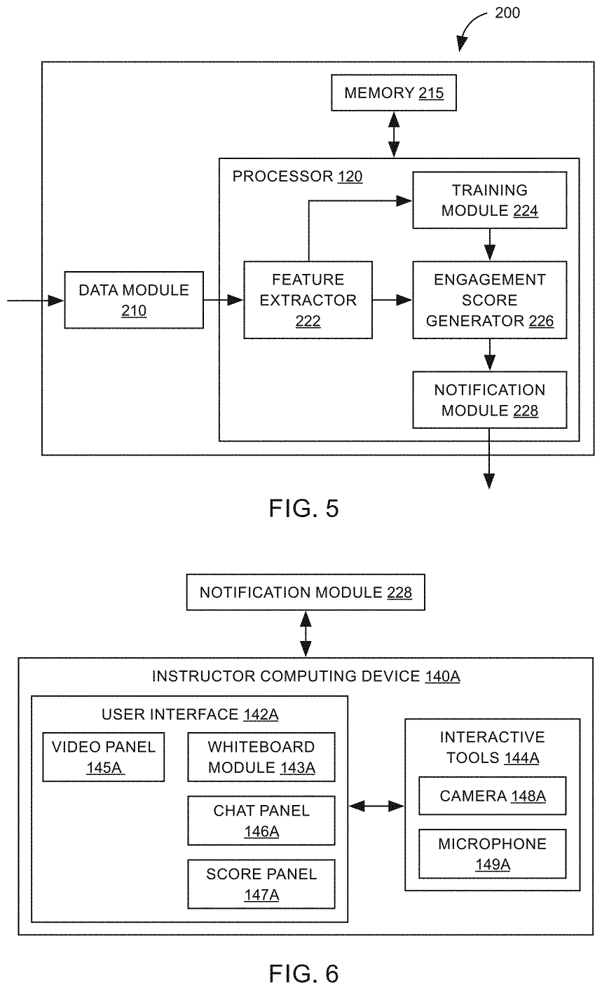

In some embodiments, the system 200 further includes one or more instructor computing devices (e.g., 140A and 140B) used by the one or more instructors 14 to deliver the learning sessions, as shown in FIG. 1. Similar to the learner computing devices of FIG. 2, the instructor computing devices include among other components, user interface, interactive tools, memory unit, and processor. FIG. 5 illustrates an example instructor computing device 140A in more detail. A user interface 142A of the instructor computing device 140A includes a whiteboard module 143A, a video panel 145A, a chat panel 146A, and a score panel 147A. Interactive tools 144A may include, for example, a camera 148A, and a microphone 149A, and are used to capture video, audio, and other inputs from the learner instructor 14A. The score panel 147A is communicatively coupled to the notification module 228 of the system 200 and configured to receive and display the real-time engagement scores to the instructor 14A in real-time.

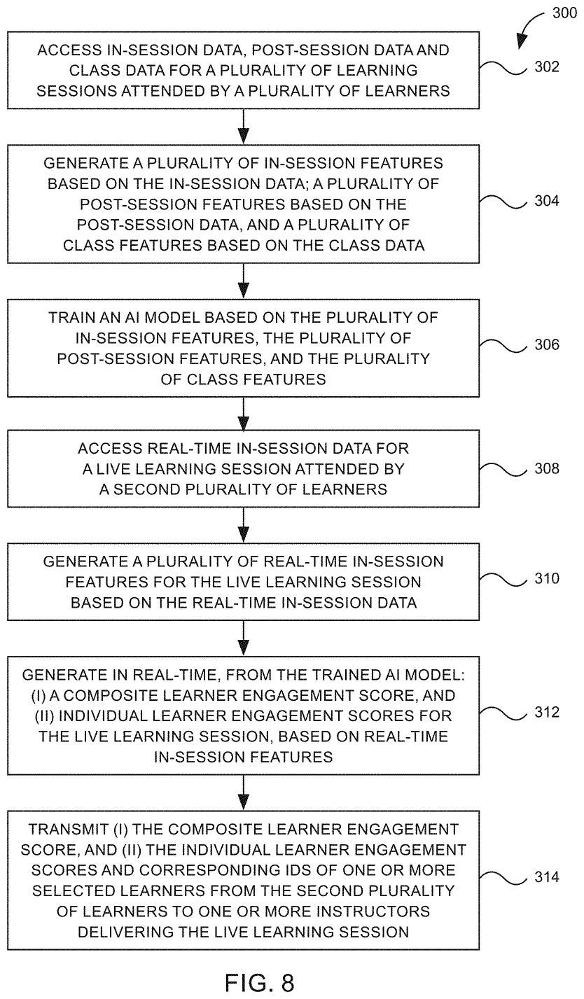

Referring now to FIG. 6, an engagement score generation system 200 in accordance with some embodiments of the present description is illustrated. The system 200 includes a data module 210, a memory 215 storing one or more processor-executable routines and a processor 220 communicatively coupled to the memory 215. The processor 220 includes a feature generator 222, a training module 224, an engagement score generator 226, and a notification module 228. Each of these components is further described in detail earlier with reference to FIG. 4. The processor 220 is configured to execute the processor-executable routines to perform the steps illustrated in the flow chart of FIG. 8.

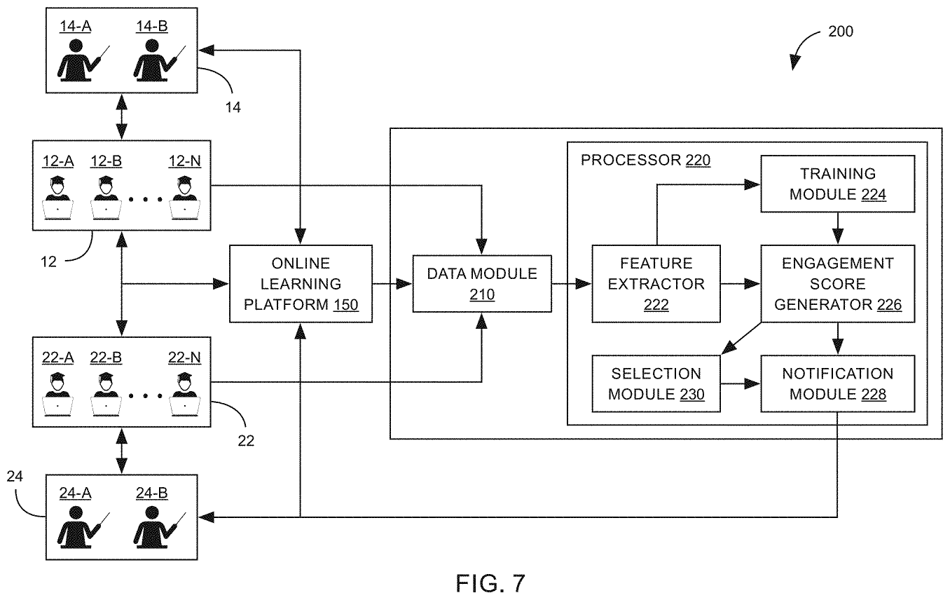

FIG. 7 illustrates an example system 200 for generating real-time learner engagement scores based on training data accessed for a plurality of learning sessions attended by a first plurality of learners 12. The plurality of learning sessions are delivered by one or more instructors 14 via the learning platform 160. FIG. 7 shows two instructors 14A and 14B for illustration purposes only and any number of instructors including one are envisaged within the scope of the description.

The system 200 is configured to generate real-time learner engagement scores for a live learning session attended by a second plurality of learners 22. The term “live learning session” as used herein refers to a learning session for which the learner engagement scores are generated in real-time while the one or more instructors are delivering the learning session. This is in contrast to learning sessions that are pre-recorded or learning sessions for which engagement scores are generated after the sessions are completed.

As shown in FIG. 7, the live learning session is delivered by one or more instructors 24 via the learning platform 160. FIG. 7 shows two instructors 24A and 24B for illustration purposes only, and any number of instructors including one are envisaged within the scope of the description. Further, in some embodiments, the one or more instructors 14 and 24 may be the same. In some other embodiments, the one or more instructors 14 and 24 may be different.

In some embodiments, the plurality of learning sessions is related to the same learning goal as the live learning session. The term “learning goal” as used herein refers to a target outcome desired from the learning session. Non-limiting examples of learning goals may include: studying for a particular grade (e.g., grade VI^{th}, grade X^{th}, grade XII^{th}, and the like), tuitions related to a particular grade, qualifying for a specific entrance exam (e.g, JEE, NEET, GRE, GMAT, SAT, LSAT, MCAT, etc.), or competing in national/international competitive examinations (e.g., Olympiads).

The plurality of learning sessions may be further related to the same subject as the live learning session or to the same topic as the live learning session, for a particular learning goal. For example, in an example embodiment, where the live learning session is related to optics (topic) in physics (subject) for grade X^{th}, the plurality of learning sessions may include all sessions related to X^{th}-grade physics (which includes all optics-related sessions), or may only include all sessions related to X^{th}-grade optics.

In some embodiments, the plurality of learning sessions may be related to the same subject for a particular learning goal as the live learning session, and includes all topics within the same subject. In such instances, the systems and methods of the present description enable generation of real-time engagement scores for new topics within the same subject. In some other embodiments, the plurality of learning sessions and the live learning session may be related to different subjects for a particular learning goal.

The first plurality of learners 12 includes all the learners that have attended the plurality of learning sessions, wherein one or more learning sessions of the plurality of learning sessions may be attended by a different set of learners. For example, for X^{th}-grade optics, multiple learning sessions for different sets of X^{th}-grade students may be delivered (parallelly or at different times) on the learning platform 160. Thus, the first plurality of learners is a sum total of all the sets of learners who have attended the plurality of learning sessions.

The first plurality of learners 12 and the second plurality of learners 22 may be the same or different. In some embodiments, the first plurality of learners 12 and the second plurality of learners 22 may be the same. In some such instances, the live learning session and the plurality of learning sessions may be related to different topics or different subjects. In some such instances, the live learning session and the plurality of learning sessions may be related to different topics within the same subject. For example, in an example embodiment where the live learning session is related to electromagnetics (topic) in physics (subject) for grade X^{th}, the plurality of learning sessions may include all sessions related to X^{th}-grade physics besides electromagnetics. In some other instances, the live learning session and the plurality of learning sessions may be related to different subjects. For example, in an example embodiment where the live learning session is related to physics (subject) for grade X^{th}, the plurality of learning sessions may include all sessions related to X^{th}-grade chemistry.

In some other embodiments, the first plurality of learners 12 and the second plurality of learners 12 are different, and have one or more learner attributes in common. Non-limiting examples of learner attributes include learning goals, age, academic performance, and the like. In some embodiments, the first plurality of learners 12 and the second plurality of learners 22 have the same learning goal.

In some embodiments, the systems and methods of the present description enable generation of a real-time learner engagement score for a new learner engaging in the learning sessions on the online learning platform for the first time. Thus, a learner engagement score may be generated for a new learner on the platform even if there is no historical data available for that learner.

Referring back to FIG. 7, the data module 210 is configured to access in-session data for the plurality of learning sessions attended by the first plurality of learners 12, post-session data corresponding to the plurality of learning sessions attended by the first plurality of learners 12, and class data for the first plurality of learners 12. In some embodiments, the data module may be further configured to access in-session data for one or more instructors 14 delivering the plurality of learning sessions. The instructor in-session data may be used to estimate an instructor quotient, which may be further used to train the AI model. Definitions and examples of in-session data, post-session data, and class data are provided herein earlier.

The feature generator 222 is configured to extract plurality of features from the in-session data, the post-session data, and the class data. The plurality of in-session features, the plurality of post-session features, and the plurality of class features are used by the training module 224 to train an AI model, as described herein earlier.

In FIG. 7, the data module 210 is also configured to access real-time in-session data for the second plurality of learners 22 attending the live learning session. In some embodiments, the data module 210 may be further configured to access in-session data for one or more instructors 24 delivering the live learning session. Definitions and examples of in-session data are provided herein earlier. The feature generator 222 is configured to generate a plurality of real-time in-session features for the live learning session based on the real-time in-session data.

The engagement score generator 226 is configured to generate, in real-time, from the trained AI model: (i) a composite learner engagement score, and (ii) individual learner engagement scores for the live learning session based on the real-time in-session features generated by the feature generator 222. In some embodiments, the data module 210, the feature generator 222, and the engagement score generator 226 are configured to access the real-time in-session data, generate the real-time in-session features, and generate the real-time engagement scores continuously during the duration of the live learning session.

The notification module 228 is configured to transmit (i) the composite learner engagement score, and (ii) individual learner engagement scores and corresponding IDs of one or more selected learners from the second plurality of learners 22 to one or more instructors 24 delivering the learning session, as shown in FIG. 7. In some embodiments, the notification module 228 is configured to transmit the engagement scores to the notification panel of an instructor computing device (shown in FIG. 5).

The composite engagement score may be transmitted to the one or more instructors 24 as a graph along with a baseline. In some embodiments, the graph showing the composite learner engagement score may be in the background of a user interface employed by the one or more instructor 24 to engage in the learning session. The notification module 228 may be further configured to bring the graph showing the composite learner engagement score in the foreground, if the composite learner engagement scores fall below the baseline by a predetermined factor.

In some such instances, the notification module 228 may be further configured to send a notification signal to the one or more instructors 24 with one or more suggestions (e.g., change in pedagogy, increased use of whiteboard module, etc.) for the remaining duration of the live learning session. The one or more instructors 24, in some embodiments, may make one or more changes in the delivery of the learning session, based on the composite engagement score and/or one or more suggestions. Thus, the systems and methods of the present description may enable real-time changes in the delivery of a learning session by one or more instructors 24, based on the composite engagement score.

The individual engagement score may be transmitted by the notification module 228 to the one or more instructors 24 in a tabular manner at regular intervals. The system 200 may further include a selection module 230 configured to select one or more learners from the second plurality of learners 22 based on a defined criterion. In some embodiments, the one or more selected learners may have an engagement score below a threshold value, and the scores and respective IDS of theses learners may be notified to the one or more instructors 24, based on which the one or more instructors 24 may be able to specifically focus their attention on these learners to help them engage better.

In some embodiments, the one or more selected learners may have an engagement score higher than a defined level, and the scores and respective IDS of theses learners may be notified to the one or more instructors 24, based on which the one or more instructors may be able to recognize and/or encourage the selected learners during the live learning session. The manner of operation of the system of FIG. 7 is described below with reference to FIG. 8.

FIG. 8 is a flowchart illustrating a method 300 for estimating real-time learner engagement scores in interactive learning sessions delivered via an online learning platform. The method 300 may be implemented using the systems of FIGS. 4, 5, and 7, according to some aspects of the present description. Each step of the method 300 is described in detail below.

At step 302, the method 300 includes accessing: in-session data for a plurality of learning sessions attended by a first plurality of learners, post-session data corresponding to the plurality of learning sessions attended by the first plurality of learners, and class data for the first plurality of learners. In some embodiments, the step 302 may further include accessing in-session data for one or more instructors delivering the plurality of learning sessions. The instructor in-session data may be used to estimate an instructor quotient, which may be further used to train the AI model. Definitions and examples of in-session data, post-session data, and class data are provided herein earlier.

At step 304, the method 300 includes generating: a plurality of in-session features based on the in-session data; a plurality of post-session features based on the post-session data, and a plurality of class features based on the class data. At step 306, the method 300 includes training an AI model based on the plurality of in-session features, the plurality of post-session features, and the plurality of class features;

The method 300, further includes, at step 308, accessing real-time in-session data for a live learning session attended by a second plurality of learners. In some embodiments, step 308 may further include accessing in-session data for one or more instructors delivering the live learning sessions. Definitions and examples of in-session data are provided herein earlier.

At step 310, the method includes generating a plurality of real-time in-session features for the live learning session based on the real-time in-session data. At step 312, the method 300 includes generating, in real-time, from the trained AI model: (i) a composite learner engagement score, and (ii) individual learner engagement scores for the live learning session, based on real-time in-session features. In some embodiments, the steps of accessing the real-time in-session data, generating the real-time in-session features, and generating the real-time engagement scores are performed continuously for the duration of the live session.

The method 300 further includes, at step 314, transmitting (i) the composite learner engagement score, and (ii) the individual learner engagement scores and corresponding IDs of one or more selected learners from the second plurality of learners to one or more instructors delivering the live learning session.

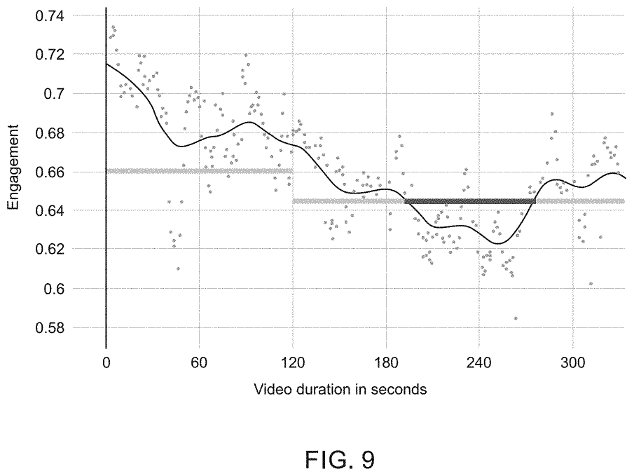

The composite engagement score may be transmitted to the one or more instructors as a graph along with a baseline. FIG. 9 shows an example of a composite engagement score transmitted to an instructor in real-time during a live learning session. In some embodiments, the graph showing the composite learner engagement score may be in the background of a user interface employed by the instructor to engage in the learning session. The method 300 may further include bringing the graph showing the composite learner engagement score in the foreground if the composite learner engagement score falls below the baseline by a predetermined factor.

In some such instances, the method 300 may further include sending a notification signal to the one or more instructors with one or more suggestions (e.g., change in pedagogy, increased use of whiteboard module etc.) for the remaining duration of the live learning session. The one or more instructors, in some embodiments, may make one or more changes in the delivery of the learning session, based on the composite engagement score and/or one or more suggestions. Thus, the systems and methods of the present description may enable real-time changes in delivery of a learning session by one or more instructors, based on the composite engagement score.

The individual engagement score may be transmitted to the one or more instructors in a tabular manner at regular intervals. The method 300 may further include selecting one or more learners from the second plurality of learners based on a defined criterion. In some embodiments, the one or more selected learners may have an engagement score below a threshold value, and the scores and respective IDS of theses learners may be notified to the one or more instructors, based on which the one or more instructors may be able to specifically focus their attention on these learners to help them engage better.

In some embodiments, the one or more selected learners may have an engagement score higher than a defined level, and the scores and respective IDS of theses learners may be notified to the one or more instructors, based on which the one or more instructors may be able to recognize and/or encourage the selected learners during the live learning session.

The systems and methods described herein may be partially or fully implemented by a special purpose computer system created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium, such that when run on a computing device, cause the computing device to perform any one of the aforementioned methods. The medium also includes, alone or in combination with the program instructions, data files, data structures, and the like. Non-limiting examples of the non-transitory computer-readable medium include, but are not limited to, rewriteable non-volatile memory devices (including, for example, flash memory devices, erasable programmable read-only memory devices, or a mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Program instructions include both machine codes, such as produced by a compiler, and higher-level codes that may be executed by the computer using an interpreter. The described hardware devices may be configured to execute one or more software modules to perform the operations of the above-described example embodiments of the description, or vice versa.

Non-limiting examples of computing devices include a processor, a controller, an arithmetic logic unit (ALU), a digital signal processor, a microcomputer, a field programmable array (FPA), a programmable logic unit (PLU), a microprocessor, or any device which may execute instructions and respond. A central processing unit may implement an operating system (OS) or one or more software applications running on the OS. Further, the processing unit may access, store, manipulate, process, and generate data in response to the execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

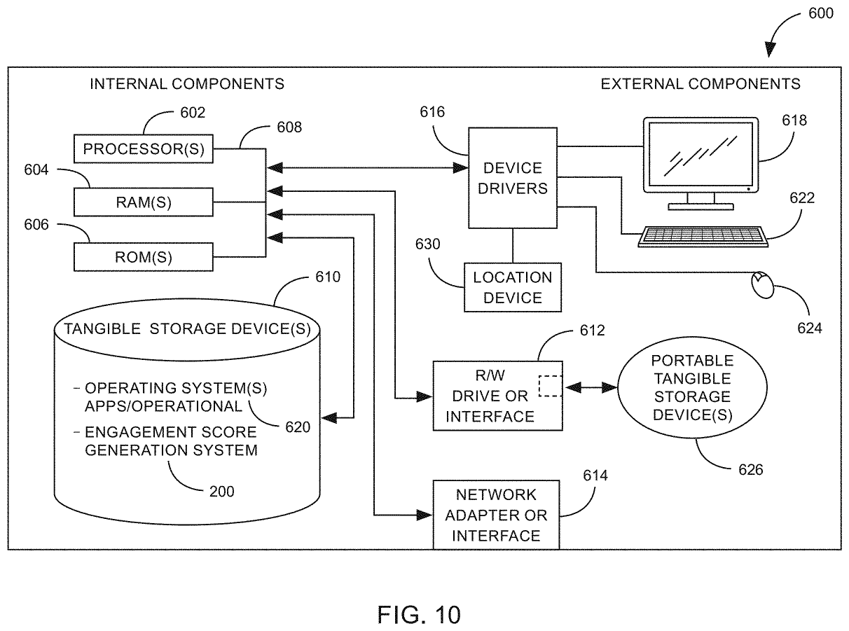

One example of a computing system 600 is described below in FIG. 10. The computing system 600 includes one or more processor 602, one or more computer-readable RAMs 604, and one or more computer-readable ROMs 606 on one or more buses 608. Further, the computer system 608 includes a tangible storage device 610 that may be used to execute operating systems 620 and the engagement score generation system 200. Both, the operating system 620 and the engagement score generation system 200 are executed by processor 602 via one or more respective RAMs 604 (which typically includes cache memory). The execution of the operating system 620 and/or engagement score generation system 200 by the processor 602, configures the processor 602 as a special-purpose processor configured to carry out the functionalities of the operation system 620 and/or the engagement score generation system 200, as described above.

Examples of storage devices 610 include semiconductor storage devices such as ROM 506, EPROM, flash memory or any other computer-readable tangible storage device that may store a computer program and digital information.

Computing system 600 also includes a R/W drive or interface 612 to read from and write to one or more portable computer-readable tangible storage devices 626 such as a CD-ROM, DVD, memory stick or semiconductor storage device. Further, network adapters or interfaces 614 such as a TCP/IP adapter cards, wireless Wi-Fi interface cards, or 3G or 4G wireless interface cards or other wired or wireless communication links are also included in the computing system 600.

In one example embodiment, the engagement score generation system 200 may be stored in tangible storage device 610 and may be downloaded from an external computer via a network (for example, the Internet, a local area network or another wide area network) and network adapter or interface 614.

Computing system 600 further includes device drivers 616 to interface with input and output devices. The input and output devices may include a computer display monitor 618, a keyboard 622, a keypad, a touch screen, a computer mouse 624, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

While only certain features of several embodiments have been illustrated and described herein, many modifications and changes will occur to those skilled in the art. It is, therefore, to be understood that the appended claims are intended to cover all such modifications and changes as fall within the scope of the invention and the appended claims.

1. A system for determining real-time learner engagement scores in interactive learning sessions delivered via an online learning platform, the system comprising:
a data module operatively coupled to the online learning platform and a plurality of computing devices used by a plurality of learners to engage in the learning sessions, the data module configured to access in-session data corresponding to a plurality of learning sessions attended by a first plurality of learners, post-session data corresponding to the plurality of learning sessions attended by the first plurality of learners, and class data for the first plurality of learners; and
a processor operatively coupled to the data module, the processor comprising:
a feature generator configured to generate a plurality of in-session features based on the in-session data; a plurality of post-session features based on the post-session data, and a plurality of class features based on the class data;
a training module configured to train an AI model based on the plurality of in-session features, the plurality of post-session features, and the plurality of class features;
an engagement score generator configured to generate, in-real-time, from the trained AI model: (i) a composite learner engagement score, and (ii) individual learner engagement scores for a live learning session attended by a second plurality of learners, based on real-time in-session features generated from real-time in-session data for the live learning session; and
a notification module configured to transmit: (i) the composite learner engagement score, and (ii) individual learner engagement scores and corresponding IDs of one or more selected learners from the second plurality of learners to one or more instructors delivering the learning session.

2. The system of claim 1, wherein the engagement score generator is configured to generate a real-time learner engagement score for a new learner engaging in the learning sessions on the online learning platform for the first time.

3. The system of claim 1, wherein the first plurality of learners and the second plurality of learners are different, and have one or more learner attributes in common.

4. The system of claim 1, wherein the first plurality of learners and the second plurality of learners are the same, and wherein the live learning session and the plurality of learning sessions are related to different topics or different subjects.

5. The system of claim 1, wherein the in-session data comprises whiteboard data, audio data, video data, messaging data, browsing data, and in-session assessment data for the first plurality of learners.

6. The system of claim 1, wherein the post-session data comprises one or more of: feedback survey data, post-session assessment data, post-session assignment data, post-session doubts data, or attendance data for the first plurality of learners.

7. The system of claim 1, wherein the class data comprises one or more of: demographic data, overall academic performance data, online platform usage data, historical subject-based assessment data, historical subject-based assignment data, historical in-session activity data, or historical attendance data for the first plurality of learners.

8. The system of claim 1, wherein the AI model comprises long short term memory recurrent neural network, convolutional neural network, or a combination thereof.

9. The system of claim 1, wherein the training module is further configured to train the AI model based on an instructor quotient.

10. The system of claim 1, wherein the notification module is configured to transmit the composite engagement score of the plurality of learners continuously, and the individual engagement scores and corresponding IDs of the one or more selected learners at defined intervals during the duration of the live learning session.

11. A system for determining real-time learner engagement scores in interactive learning sessions delivered via an online learning platform, the system comprising:
a memory storing one or more processor-executable routines; and
a processor cooperatively coupled to the memory, the processor configured to execute the one or more processor-executable routines to:
access: in-session data for a plurality of learning sessions attended by a first plurality of learners, post-session data corresponding to the plurality of learning sessions attended by the first plurality of learners, and class data for the first plurality of learners;
generate: a plurality of in-session features based on the in-session data, a plurality of post-session features based on the post-session data, and a plurality of class features based on the class data;
train an AI model based on the plurality of in-session features, the plurality of post-session features, and the plurality of class features;
access real-time in-session data for a live learning session attended by a second plurality of learners;
generate a plurality of real-time in-session features for the live learning session based on the real-time in-session data;
generate, in real-time, from the trained AI model: (i) a composite learner engagement score, and (ii) individual learner engagement scores for the live learning session, based on real-time in-session features for the live learning session; and
transmit (i) the composite learner engagement score, and (ii) the individual learner engagement scores and corresponding IDs of one or more selected learners from the second plurality of learners to one or more instructors delivering the live learning session.

12. The system of claim 11, wherein the system is configured to determine a real-time learner engagement score for a new learner engaging in the learning sessions on the online learning platform for the first time.

13. The system of claim 11, wherein the first plurality of learners and the second plurality of learners are different, and have one or more learner attributes in common.

14. The system of claim 11, wherein the first plurality of learners and the second plurality of learners are the same, and wherein the live learning session and the plurality of learning sessions are related to different topics or different subjects.

15. The system of claim 11, wherein the in-session data comprises whiteboard data, audio data, video data, messaging data, browsing data, and in-session assessment data for the first plurality of learners.

16. The system of claim 11, wherein the post-session data comprises one or more of: feedback survey data, post-session assessment data, post-session assignment data, post-session doubts data, or attendance data for the first plurality of learners.

17. The system of claim 11, wherein the class data comprises one or more of: demographic data, overall academic performance data, online platform usage data, historical subject-based assessment data, historical subject-based assignment data, historical in-session activity data, or historical attendance data for the first plurality of learners.

18. A method for determining real-time learner engagement scores in interactive learning sessions delivered via an online learning platform, the method comprising:
accessing: in-session data for a plurality of learning sessions attended by a first plurality of learners, post-session data corresponding to the plurality of learning sessions attended by the first plurality of learners, and class data for the first plurality of learners;
generating: a plurality of in-session features based on the in-session data; a plurality of post-session features based on the post-session data, and a plurality of class features based on the class data;
training an AI model based on the plurality of in-session features, the plurality of post-session features, and the plurality of class features;
accessing real-time in-session data for a live learning session attended by a second plurality of learners;
generating a plurality of real-time in-session features for the live learning session based on the real-time in-session data;
generating, in real-time, from the trained AI model: (i) a composite learner engagement score, and (ii) individual learner engagement scores for the live learning session, based on real-time in-session features for the live learning session; and
transmitting (i) the composite learner engagement score, and (ii) the individual learner engagement scores and corresponding IDs of one or more selected learners from the second plurality of learners to one or more instructors delivering the live learning session.

19. The method of claim 18, wherein the first plurality of learners and the second plurality of learners are different, and have one or more learner attributes in common.

20. The method of claim 18, wherein the first plurality of learners and the second plurality of learners are the same, and wherein the live learning session and the plurality of learning sessions are related to different topics or different subjects.
